(19) United States
(12) Patent Application Publication
(10) Pub. No.: US 2003/0149885 A1
(43) Pub. Date: Aug. 7, 2003

(54) Transfer and copy prevention digital recording media protection and master disk manufacturing method

(75) Inventors: Ko-Cheng Fang, Taichung (TW); Chun-Chieh Lee, Taipei Hsien (TW)

Correspondence Address: BRUCE H. TROXELL, SUITE 1404, 5205 LEESBURG PIKE, FALLS CHURCH, VA, 22041, US

(73) Assignee: Ko-Cheng FANG

(21) Appl. No.: 10/114,478

(22) Filed: Apr. 3, 2002

(30) Foreign Application Priority Data
Feb. 5, 2002 (TW) 091101978

(51) Int. Cl. G06F 12/14

(52) U.S. Cl. 713/193; 380/201

(57) ABSTRACT

A transfer and copy prevention digital recording media protection and master disk manufacturing method (the digital recording media referring to standard specification recording methods such as CD, VDC, DVD, MO, and flashdisks, etc.), the procedure of which involves the following steps. When digital recording media is press fabricated, an encrypted protection program and various protective schemes that constitute the content are imposed to produced a standard original disks (protected disks with built-in transfer and copy prevention technology). The protection program and protective scheme are not started if such original disks are placed in a conventional player, but play normally. When placed into a computer and read, the encrypted protection program is started and executed, and the disk will play normally if it is not unlawfully transferred and copied. However, if examination reveals that unlawful transfer and copy has transpired, the various protective schemes (for example, viruses, termination of execution, and automatic notification of the original manufacturer, etc.) are executed to thereby protect against the unlawful transfer and duplication of the digital recording media contents.

### BACKGROUND OF THE INVENTION

1. Field of The Invention

The invention herein relates to a transfer and copy prevention digital recording media protection and master disk manufacturing method.

2. Description of Related Art

In the present age of unceasing strides in knowledge and rapid information transmission, digital recording media are the best methods of storage and transfer. However, the continuous release of the latest digital recording media duplicating machines and their widespread usage and, furthermore, the growth of underground pirated edition factories have resulted in deliberate copying and even sales that invisibly intrude upon the creative efforts of inventors and authors. These practices not only have adverse effects such as the discouraging of new works, but also result in business investment and economic losses of considerable proportions.

Transfer and copy prevention technology is now being researched and developed in nearly every nation around the world. However, a number of new safeguarding approaches have failed due to market acceptance issues. These include the Safe_Disk2 protection technology often utilized in the United States and Japan that rigorously tests the compatibility of user optical disk drives, but has resulted in the incapacitating of normal read operations among many purchasing users. Another example is the Midbar technology developed in Israel, which substitutes erroneous data for certain music numerals to indicate control over information. Conventional players are incapable of reading and interpreting the erroneous information, but when read in a computer, this results in signal discrimination faults that precludes listening to an original edition by the purchaser. In addition to being inconvenient to use, said methods are incapable of effectively preventing transfer and copy.

### SUMMARY OF THE INVENTION

In view of the said factors, the inventor of the invention herein researched and developed a new protection technology and method of preventing the transfer and copying of standardized specification digital recording media, specifically referring to a type of process wherein various protective means are first incorporated onto master disks during their fabrication to manufacture production-use master disks such that after the distribution versions of digital recording media are released on the market, code breakage by pirated edition factories as well as copying on personal computer recording machines is of greater difficulty to thereby prevent duplication.

The transfer and copy prevention digital recording media protection technology of the invention herein and its formative method consists of deliberately mixing embedded data errors in the recording signals such that errors appear during pirate copying. The data reading method of a computer is not identical to that of a player due to differences in how a computer and a player read and evaluate data. Utilizing this overlooked aspect, data errors (such as oversized file formats, corrupt tracks, crosslinks, false files and directories, and abnormal records, etc.) are included into master disks and, furthermore, the embedded errors are encrypted when recorded. As such, this results in a level of perplexity that renders duplication virtually impossible by pirate copyists, but does not affect playing or execution by lawful purchasers because the lawful users have a program provided by the manufacturer that contains checking and decryption functions or guides for ignoring the embedded errors (hereafter referred to as the check program) which enables normal playing and execution in a computer.

To enable the examination committee to further understand the structure, features, and objectives of the present invention, the brief description of the drawings is followed by detailed description of the most preferred embodiments, wherein the special terminology utilized is defined below:

| | |
|---|---|
| Manufacturer | A publisher/distributor and developer of digital |
| | recording media. |
| User | A consumer that purchases commercially available |
| | products published, distributed, or produced by the |
| | manufacturer. |
| Embedded error | Errors that are exactingly created through the |
| | invention herein that serve as the key (for example, |
| | invalid tracks, corrupted tracks, hysteresis loops, |
| | altered data formats, or virus, and oversized files, etc.) |
| | required by the check program which achieves the |
| | objective of protecting the intellectual property rights |
| | of the manufacturer. |
| Master disk | The original recording media data that is produced by |
| | the manufacturer. |
| Standard original | A transfer- and copy-proof disk based on the |
| disk | protection technology herein. |
| Transfer and copy | A master disk that has undergone the protective |
| prevention digital | processing of the invention herein and which provides |
| recording media | for the production of standard original disks. |
| protection master | |
| disk | |
| Check program | Supplied to transfer- and copy- prevented digital |
| | recording media original disk users for reading |
| | encrypted data or avoiding embedded errors. |
| Check code | Confirms a lawful user through the check program, |
| | with the said code situated in memory or stored in |
| | other recording media for future usage by the user |
| | without requiring the re-execution of the check |
| | program. |

### BRIEF DESCRIPTION OF THE DRAWINGS

The present invention can be more fully understood by reference to the following description and accompanying drawings, in which:

FIG. 1(a) is a diagram of an audio CD operating method; and

FIG. 2(a) is a diagram of the transfer- and copy-proof media operating method.

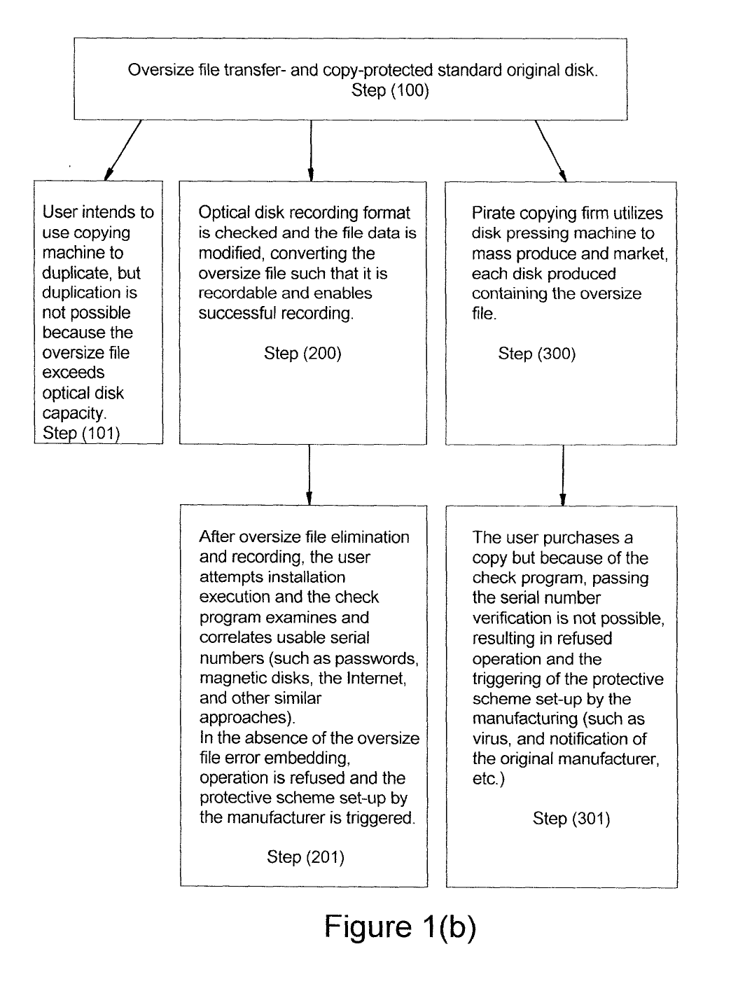

### DETAILED DESCRIPTION OF THE PREFERRED EMBODIMENTS

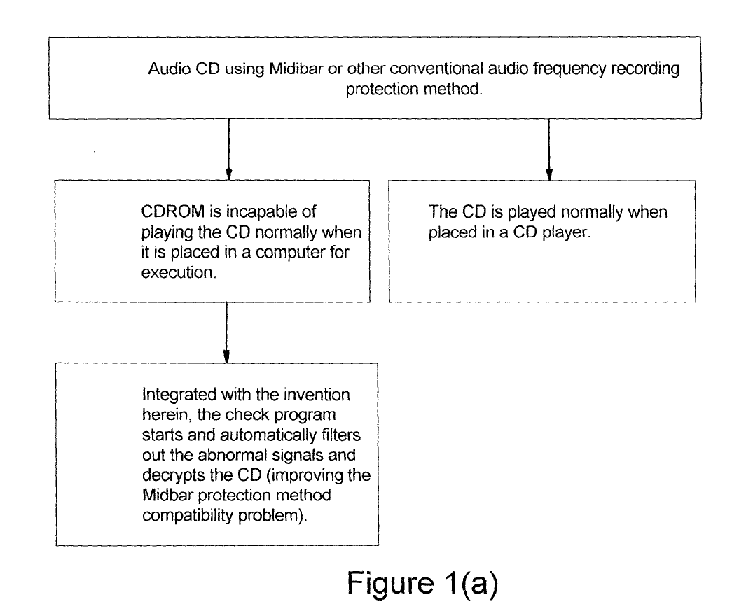

Referring to FIG. 1(a), the audio CD disk already has Midbar or other audio frequency recording protection and although the recording format is normally playable in a player, it cannot be normally read in a computer. However, utilizing said conventional protection integrated with the invention herein, the user obtains a check program verification from a manufacturer through a designated means (the various means include downloading, postal delivery, or placement on an optical disk) and deploys the program for guidance pass recorded errors and encryption to enable normal playing in a computer, thereby providing the user a complete application environment.

Referring to FIG. 1(b), the flowchart of an embodiment of the invention herein that illustrates the executing of verification on a computer by the digital recording media transfer and copy protection mechanism.

The factory outputs a product on an oversize file formatted disk (Step 100).

A computer user intends to duplicate by transference and copying (Step 101), but since the oversize file format exceeds CD-R recording media capacity, an error results and duplication is not possible.

Users having a deep understanding of optical disk structure can eliminate the oversize file and thereby complete the recording (Step 200), the non-original disk is then placed into the optical disk drive and executed, with the check program started and executed as follows:

1. The password is inputted.

2. The website connection is established to execute verification.

3. The software serial number is inputted for verification.

4. The key is inputted.

5. Or, another verification means (such as a hard disk, another storage media disk, wireless network, electronic mail, or protection lock, etc.) is substituted.

6. The presence or absence of encryption irregularities in the recorded oversize file is confirmed.

If the verification fails, continued operation is not possible and the protection scheme set up by the manufacturer is triggered (Step 201).

Pirate copy manufacturers can easily break the oversize file program or the encryption program, which requires several months or more during which time the programs protect the original disks, enabling the eventual marketing (Step 300) of code-broken reproductions. However, when the non-original disk users attempt computer installation, the check program verification fails (for example, the serial number inputted for registration is already in use by someone else) and triggers the protection scheme set up by the manufacturer (Step 301); if the pirate copy maker wants to transfer and copy by mirroring, the non-original disk user is still implicated.

The master disk media transfer and copy prevention of the invention herein involves direct error embedding as well as encrypted or non-encrypted direct writes such that when executed, the check program encrypts or guides the reading of normal data (this increases the degree of complexity to circumvent rapid code breaking and allows the manufacturer to forestall major losses), wherein the error embedded data can be randomly or sequentially situated. An example of this is the largeness of the oversize file (The recorded size indicated of such a file is 1,000 MB, which is considerably greater than the 650 MB standard capacity of an optical disk.) into which the errors are embedded (The errors result in an indicated file size of 1,000 MB and the recorded size location is examined for unlawful transfer and copying or whether the required key was inputted during the normal execution of the check program.) and, furthermore, the errors can be embedded in a concentrated arrangement (such as 200 sequential errors consolidated into one) or in a dispersed arrangement (One error bit added after every 100 bits.)

The protection technology of the invention herein is such that the check program can be installed segmentally and thereby commence the execution of an examination at various points along the contents of the digital recording media and also request the user to execute the check program when the digital recording media has been played midway to achieve the objective of protection. To execute the transfer and copy prevention of digital recording media content, a decryption file must be properly formatted and read into the memory of a computer, enabling the lawful user to skip or decrypt the errors embedded and thereby read data correctly without further problems. The decryption content can be “temporarily” stored in computer memory, but since deletion occurs when the system is switched off, it has to be reloaded. An unlocking code approach has been produced for other digital recording media (such as diskettes and hard disks, etc.) and encryption is only required once to minimize user inconvenience. The unlocking code has identification characteristics and its record includes corresponding hardware- and software-generated numbers such as computer mainboard BIOS, CPU batch serial numbers, optical disk drive numbers, peripheral interface cards, displays, network cards, Mac addresses, as well as operating system versions and serial numbers, and so on, all of which serve as a basis of detection through the generated unlocking code. If an unlocking code is directly duplicated to another machine, execution will not be possible due to the differing specifications of the two systems, thereby achieving the objective of preventing misappropriated transfer and copying. When the check program discovers abnormal user duplication, it automatically takes the countermeasures of the protection scheme set up by the manufacturer (such as launching a virus, sending an e-mail to the manufacturer, terminating execution, and other similar approaches).

The master disk production program and data in the digital recording media content of the invention herein utilize an encryption routine during manufacture that maintains and protects the independence of the master disk production database. The master disk production program database provides a manufacturing protection method; the protection method is cumulative and can be further developed over time to additionally accommodate new protection technology into its database, thereby allowing the usage of the latest protection technology by the original customer without requiring further protection data upgrades, but only reinstallation.

The invention herein provides a method for the manufacturing of transfer- and copy-protected digital recording media master disks that includes the following procedures:

1. A protection database is supplied that affords manufacturers a selectable error embedding method.

2. The said error embedding requirements also allows for the reading of a manufacturer's original data.

3. The said error embedding as well as encrypted or non-encrypted data is written into said digital recording media master disks to produce transfer- and copy-proof master disks.

The database protection method includes the inputting of check methods consisting of artificial track corruption, hysteresis loop, empty data folder, transient file, virus data, massive file, and format altering capabilities to produce transfer- and copy-protected digital recording media master disks.

In summation of the foregoing section, the transfer and copy prevention digital recording media protection technology and method of the invention herein has the following advantages over that of the conventional counterparts. They improve upon the shortcomings of conventional optical disk protection methods by providing a combination of various approaches that require individuals engaged in unlawful transfer and copying to spend a considerably longer period of time before code is successfully broken, thereby achieving the objective of optical disk protection.

Although the most preferred embodiments of the invention herein have been disclosed in the preceding description, they shall not be construed as limitations of the invention herein and, furthermore, all modifications and embellishments thereof undertaken by persons skilled in the technology shall remain protected within the spirit and scope of the present invention as defined by the following claims attached to the patent application of the invention herein.

What is claimed is:

1. A transfer and copy prevention digital recording media protection method, comprising of the following procedures:
step 1: digital recording media is placed into a computer to commence the reading of data;
step 2: a check program is started to verify the data archived on said digital recording media and whether it is a standard original disk produced by a manufacturer;
step 3: if said digital recording media contains the embedded errors of the invention herein, this indicates that said digital recording media is a standard original disk produced by the manufacturer; a check program in the memory of a computer then decrypts the output or guides the reading or correct execution of the data and reads the contents of said digital recording media; and
step 4: if said digital recording media does not contain said embedded errors, the protection scheme set-up by the manufacturer is executed to safeguard the content of said digital recording media from unlawful transferring and copying.

2. The transfer and copy prevention digital recording media protection method according to claim 1, wherein said digital recording media consists of CD, VCD, DVD, MO, high-density magnetic tape, flash disks, and other standardized specification digital storage media.

3. The transfer and copy prevention digital recording media protection method according to claim 1, wherein said check program instructs optical disk drives how to skip or decrypt said embedded errors and thereby read data correctly.

4. The transfer and copy prevention digital recording media protection method according to claim 1, wherein said embedded errors can be archived in a concentrated arrangement.

5. The transfer and copy prevention digital recording media protection method according to claim 1, wherein said embedded errors can be archived in a dispersed arrangement.

6. The transfer and copy prevention digital recording media protection method according to claim 1, wherein said embedded errors can be of a specification wherein they are recorded by adding one or more, contiguous or scattered error bits.

7. The transfer and copy prevention digital recording media protection method according to claim 1, wherein said embedded errors are recorded into position fully encrypted or partially encrypted.

8. The transfer and copy prevention digital recording media protection method according to claim 1, wherein said check program correlation is executed when said digital recording media begins operation or executed after said digital recording media is operating.

9. The transfer and copy prevention digital recording media protection method according to claim 1, wherein said decryption record is temporary and deleted when the system is switched off.

10. The transfer and copy prevention digital recording media protection method according to claim 1, wherein said decryption file generates an encrypted or a non-encrypted unlocking code that is permanently stored in other recording media such that the user is not required to repeat verification.

11. The transfer and copy prevention digital recording media protection method according to claim 10, wherein said unlocking code correlates the hardware and software of a computer (such as computer mainboard BIOS, CPU serial numbers, optical disk drive drive numbers, peripheral interface cards, displays, network cards, and operating system versions and serial numbers, etc.) and additionally detects according to a generated check code.

12. The transfer and copy prevention digital recording media protection method according to claim 1, wherein said protection scheme check method is based on protection requirements and initiates the correlation of check numbers (such as software registration numbers, software serial numbers, and optical disk serial numbers, etc.) or correlates said check numbers through an external device (such as a magnetic disk, another optical disk, magnetic card, or the Internet, etc.).

13. The transfer and copy prevention digital recording media protection method according to claim 1, wherein said manufacturer uses software designing to create protective method combinations of embedded errors such as invalid tracks, hysteresis loops, corrupted tracks, altered data formats, or virus data, and other similar items.

14. The transfer and copy prevention digital recording media protection method according to claim 1, wherein said protection scheme can be segmentally or wholly configured in transfer- and copy-protected digital recording media and, furthermore, with encryption function support.

15. The transfer and copy prevention digital recording media protection method according to claim 1, wherein the protection scheme set up by the manufacturer is capable of launching a virus, sending an e-mail to the manufacturer, terminating execution, and other protective countermeasures.

16. A transfer and copy prevention digital recording media protection master disk method, comprising of the following procedures:
a data protection table is supplied to provide for a transfer- and copy-protected master disk.
the original data is read-in to produce transfer- and copy-protected recording media.
an encryption record is produced for the original data based on manufacturer requirements.
whereby said encryption record, correct data, and embedded errors are recorded to said transfer- and copy-protected digital recording media master disk.

17. The transfer and copy prevention digital recording media protection master disk method according to claim 16, wherein said digital recording media consists of CD, VCD, DVD, flash disks, high-density magnetic tape, MO, and other standardized specification digital storage media.

18. The transfer and copy prevention digital recording media protection master disk method according to claim 16, wherein said method can be utilized in combination with said data protection table to generate single or multiple embedded errors.

19. The transfer and copy prevention digital recording media protection master disk method according to claim 16, wherein said transfer- and copy-protected digital recording media master disk method is capable of including a check program or a manufacturer-designated means that retrieves the check and decryption program.

20. The transfer and copy prevention digital recording media protection master disk method according to claim 18, wherein said data protection table is capable of setting up corrupted tracks, empty data folders, virus data, massive files, altered formats, and other similar items.

21. The transfer and copy prevention digital recording media protection master disk method according to claim 19, wherein said manufacturer-designated means includes downloading, postal delivery, and other related means.
